(19) United States
(12) Patent Application Publication
(10) Pub. No.: US 2012/0194421 A1
(43) Pub. Date: Aug. 2, 2012

(54) TERMINAL AND METHOD FOR PROVIDING USER INTERFACE LINKED TO TERMINAL POSTURE

(75) Inventors: Tae-Hwan SON, Suwon-si (KR); Sung-Joo Ahn, Seoul (KR); Jin-He Jung, Suwon-si (KR)

(73) Assignee: Samsung Electronics Co., Ltd., Suwon-si (KR)

(21) Appl. No.: 13/363,963

(22) Filed: Feb. 1, 2012

(30) Foreign Application Priority Data
Feb. 1, 2011 (KR) 10-2011-0010219

(51) Int. Cl. G09G 5/00

(52) U.S. Cl. 345/156

(57) ABSTRACT

A terminal and method for providing user interfaces linked to postures of a terminal, whereby a key input signal is received from any one of function keys located at both sides of the terminal, a posture of the terminal is determined in response to the received key input signal, a user interface screen corresponding to the determined posture of the terminal is provided, and settings of the terminal are changed according to the determined posture of the terminal, thereby increasing convenience of a user interface without use of a complicated sensor system.

### PRIORITY

This application claims priority under 35 U.S.C. §119(a) to a Korean Patent Application filed in the Korean Intellectual Property Office on Feb. 1, 2011 and assigned Serial No. 10-2011-0010219, the contents of which are incorporated herein by reference.

### BACKGROUND OF THE INVENTION

1. Field of the Invention

The present invention relates to providing user interfaces linked to portable terminal postures (or terminal directions).

2. Description of the Related Art

Portable terminals generally include user input buttons such as volume, hold, and camera buttons, and functional devices such as a microphone, front and rear speakers, and a camera. These user input buttons and functional devices are mounted to the outer side of the portable terminals.

FIG. 1 illustrates a conventional portable terminal.

Referring to FIG. 1, the conventional portable terminal includes a call start and end button 100, a hold button 101, a volume button 102, a camera button 103, a camera 104, a front speaker 105, a rear speaker (not shown), a microphone 106, and a Liquid Crystal Display (LCD) screen 107.

This conventional portable terminal is implemented to fixedly (or non-rotatably) control a user interface (UI) on a display screen such as the LCD screen 107. A screen direction of the portable terminal in FIG. 1 is defined as a normal direction, and the opposite direction is defined as a reverse direction. A full touch screen terminal has a large rectangular touch screen covering almost all of one surface due to the increasing trend of touch screen implementation. Accordingly, the front surface of the full touch screen terminal has a vertically symmetrical shape, and the rear surface thereof has only a camera, for minimized component layout. Moreover, the number of buttons mounted on the full touch screen terminal is also minimized, so that most manipulations may be performed on the touch panel.

As described above, the conventional portable terminal has a full touch screen having a fixed and non-rotatable direction, causing an inconvenience to the user.

In addition, although bar-type full touch screen terminals have a hold function, having to manipulate a hold button is an inconvenience to users.

Moreover, due to simplification of button arrangement of these full touch screen terminals, when a user holds a terminal located in a bag or pocket or in a dark place, it is difficult for the user to discriminate the upper side of the terminal from the lower side.

Accordingly, when the user wrongly perceives the terminal's posture, the user must inconveniently turn the terminal by 180° to press a button for releasing the hold.

### SUMMARY OF THE INVENTION

An aspect of the present invention is to provide a user display apparatus and method in which the foregoing problems with the conventional portable terminal are solved, thereby enhancing user convenience.

According to one aspect of the present invention, there is provided a terminal for providing user interfaces linked to postures of the terminal, including a key input unit having at least two function keys located at both sides of the terminal, and a controller for determining, when a key input signal is received from any one of the at least two function keys, a posture of the terminal in response to the received key input signal, providing a user interface screen corresponding to the determined posture of the terminal, and changing settings of the terminal according to the determined posture of the terminal.

According to another aspect of the present invention, there is provided a method of providing user interfaces linked to postures of a terminal, including receiving a key input signal from any one of at least two function keys located at both sides of the terminal, determining a posture of the terminal in response to the received key input signal, providing a user interface screen corresponding to the determined posture of the terminal, and changing settings of the terminal according to the determined posture of the terminal.

### BRIEF DESCRIPTION OF THE DRAWINGS

The above and other objects, features and advantages of the present invention will become more apparent from the following detailed description when taken in conjunction with the accompanying drawing in which:

FIG. 1 illustrates a conventional portable terminal;

FIG. 2 illustrates a terminal according to an embodiment of the present invention;

FIG. 3 is a block diagram of the terminal according to an embodiment of the present invention;

FIG. 4 illustrates a process of providing a user interface screen by the terminal 200 in response to a terminal state change, according to an embodiment of the present invention;

FIG. 5 illustrates an instance in which a terminal's posture corresponds to a normal direction, according to an embodiment of the present invention; and

FIG. 6 illustrates an instance in which a terminal's posture corresponds to a reverse direction, according to an embodiment of the present invention.

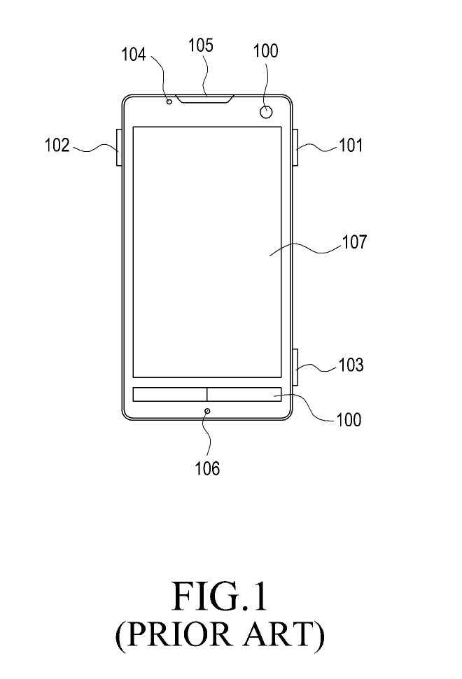

### DETAILED DESCRIPTION OF EMBODIMENTS OF THE INVENTION

Embodiments of the present invention will be described herein below with reference to the accompanying drawings. In the following description and the accompanying drawings, well-known functions or constructions are not described in detail for the sake of clarity and conciseness.

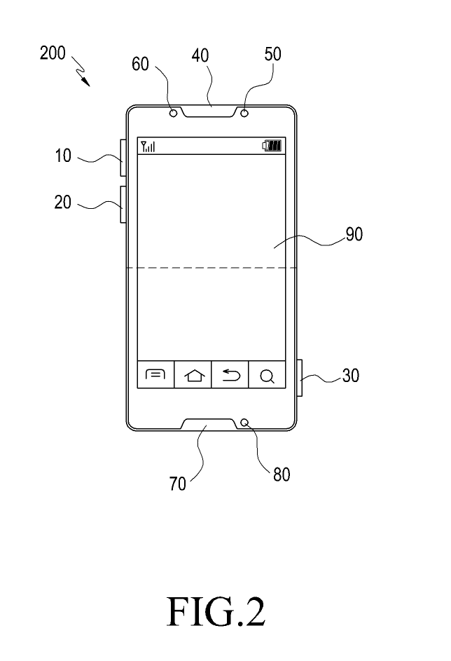

FIG. 2 illustrates a terminal 200 according to an embodiment of the present invention.

Referring to FIG. 2, the terminal 200 includes a first hold key 10 and a second hold key 30 for a hold or camera function, wherein any one of the first and second hold keys 10 and 30 is located at an upper portion of one side (i.e., the left side in FIG. 2) of the terminal 200, and the other one is located at a lower portion of the opposite side (i.e., the right side in FIG. 2) of the terminal 200.

In FIG. 2, assuming that a posture of the terminal 200 is a reference posture, the first hold key 10 is located at an upper left side based on the reference posture of the terminal 200, and the second hold key 30 is located at a lower right side corresponding to a direction diagonal to the first hold key 10.

The terminal 200 also includes a top and bottom symmetrical dual speaker including a first stereo speaker 40 and a second stereo speaker 70 and a top and bottom symmetrical dual microphone including a first microphone 50 and a second microphone 80. The top and bottom symmetrical dual microphone selectively functions in response to determination of an up/down posture of the terminal 200.

The terminal 200 further includes a camera 60, a volume key 20, and a touch screen 90, such as an LCD touch panel. When the reference posture of the terminal 200 is changed, the direction of a User Interface (UI) screen on the touch screen 90 is determined. In this case, the terminal 200 also changes touch input settings on the touch screen 90 in response to the change of the reference posture.

According to the present invention, a posture of the terminal 200 is determined depending on a hold key input from among the first and second hold keys 10 and 30 regardless of a terminal handling direction of a user. For example, if it is assumed that the terminal 200 is divided by a line crossing from the left to the right on the center of the terminal 200, as shown, the divided upper portion is an upper part of the terminal 200, the divided lower portion is a lower part of the terminal 200, and the posture of the terminal 200 that is shown in FIG. 2 is a normal direction (posture), relative to a user in a normal standing or seated position. In this case, a reverse direction (posture) of the terminal 200 indicates that the terminal 200 is situated upside down.

When the user ends a movie or an application, such as an image viewer that automatically provides a horizontal-view function while in use, a direction of the user interface screen corresponding to a posture of the terminal 200 that is set by a hold key input is provided, and the terminal 200 maintains the direction of the user interface screen until a next hold key input is received, at which time existing settings are initialized and a posture of the terminal 200 is re-determined.

According to the posture determination of the terminal 200, the direction of the user interface screen, settings of the dual speaker and the dual microphone, and touch function settings are all changed.

In detail, for conventional terminals, a touch reference of a touch screen is hard-coded when the touch screen is initialized. That is, to rotate the touch screen and a touch interface, a related driver must be additionally implemented.

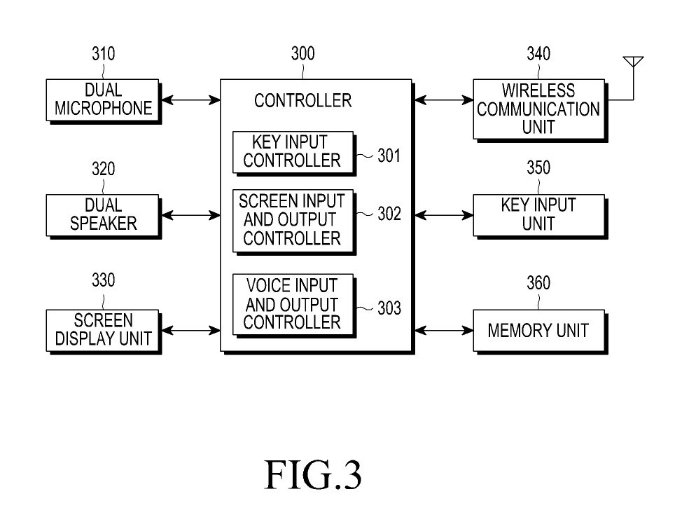

According to the present invention, a user interface screen and touch rotation function in response to an external input are provided by a touch screen driver, such as a screen input and output controller (refer to 302 of FIG. 3), and further provided are an Application Programming Interface (API) for rotating a screen by 180° and changing a touch reference position corresponding to the rotated posture, and a terminal platform for implementing an interface for the API.

According to the present invention, convenience of a user interface increases without the use of a complicated sensor system by determining and providing a key map and user interface screen direction to provide an easy manipulation according to a terminal handling direction of the user.

FIG. 3 is a block diagram of the terminal 200 according to an embodiment of the present invention.

Referring to FIG. 3, the terminal 200 includes a controller 300, a dual microphone 310, a dual speaker 320, a screen display unit 330, a wireless communication unit 340, a key input unit 350, and a memory unit 360.

The controller 300 includes a key input controller 301, a screen input and output controller 302, and a voice input and output controller 303.

The key input controller 301 determines a hold key, which has output a key input signal, from among the first and second hold keys 10 and 30 based on the key input signal received from the key input unit 350.

If the determined hold key is the first hold key 10, the key input controller 301 determines that a posture of the terminal 200 corresponds to the normal direction, and if the determined hold key is the second hold key 30, the key input controller 301 determines that the posture of the terminal 200 corresponds to the reverse direction.

According to the present invention, terminal state information on whether the posture of the terminal 200 corresponds to the normal direction or the reverse direction is pre-set according to a key input signal, and information for re-setting a posture of the terminal 200, a user interface screen direction, a key function, a dual speaker function, a dual microphone function, and a touch function is determined by using previously stored tables, such as Table 1 and Table 2 below.

Table 1 indicates the pre-stored key input signal by which a terminal state corresponds to the normal direction or the reverse direction.

TABLE 1

| Key input signal | Terminal state |
|---|---|
| First hold key signal | Normal direction |
| Second hold key signal | Reverse direction |

Based on Table 1, the key input controller 301 determines that the terminal state corresponds to the normal direction if the first hold key signal is received from the key input unit 350 and determines that the terminal state corresponds to the reverse direction if the second hold key signal is received from the key input unit 350.

Table 2 indicates pre-stored terminal settings, such as a key function, a user interface screen direction, a display screen direction, a speaker function, a microphone function, and a touch screen configuration, according to whether the terminal state corresponds to the normal direction or the reverse direction.

TABLE 2

| | | UI screen | | |
|---|---|---|---|---|
| | | and | | Touch |
| Terminal | | display | Speaker and | recognition |
| state | Key function | screen | microphone | screen |
| Normal | First hold key: | Default UI | Second | Default touch |
| direction | hold function | screen and | microphone: | recognition |
| | Second hold | display | voice | configuration |
| | key: camera | screen | transmitter | |
| | function | | First speaker: | |
| | | | voice receiver | |
| Reverse | First hold key: | Rotating | First | Rotating |
| direction | camera | default UI | microphone: | default touch |
| | function | screen and | voice | recognition |
| | Second hold | display | transmitter | configuration |
| | key: hold | screen | Second | by 180° |
| | function | by 180° | speaker: voice | |
| | | | receiver | |

The key input controller 301 transmits terminal state information corresponding to the determined posture of the terminal 200 to the screen input and output controller 302 and the voice input and output controller 303. The terminal state information indicates whether a posture of the terminal 200 corresponds to the normal direction or the reverse direction. In addition, the key input controller 301 sets a hold key except for one that has generated a key input signal from among the two top and bottom symmetrically located hold keys as an input key for executing a specific function. For example, with reference to Table 2, if the determined hold key is the first hold key 10, the key input controller 301 sets the second hold key 30 as a camera capturing key for the camera function, and if the determined hold key is the second hold key 30, the key input controller 301 sets the first hold key 10 as the camera capturing key.

The screen input and output controller 302 provides a user interface screen according to the received terminal state information. In detail, with reference to Table 2, if the determined posture of the terminal 200 corresponds to the normal direction, the screen input and output controller 302 outputs a default user interface screen, and if the determined posture of the terminal 200 corresponds to the reverse direction, the screen input and output controller 302 outputs a modified user interface screen obtained by rotating the default user interface screen by 180°.

The voice input and output controller 303 determines a voice transmitter and a voice receiver to be used for call transmission and reception according to the received terminal state information. Specifically, if the determined posture of the terminal 200 corresponds to the normal direction, the voice input and output controller 303 determines the first speaker 40 located at the upper part of the terminal 200 as the voice receiver and determines the second microphone 80 located at the lower part of the terminal 200 as the voice transmitter. Otherwise, if the determined posture of the terminal 200 corresponds to the reverse direction, the voice input and output controller 303 determines the first microphone 50 located at the upper part of the terminal 200 as the voice transmitter and determines the second speaker 70 located at the lower part of the terminal 200 as the voice receiver.

The dual microphone 310 may include the first microphone 50 located at the upper part of the terminal 200 and the second microphone 80 located at the lower part of the terminal 200, wherein the first and second microphones 50 and 80 are symmetrical to each other for purposes of user convenience.

The dual speaker 320 may include the first speaker 40 located at the upper part of the terminal 200 and the second speaker 70 located at the lower part of the terminal 200, wherein the first and second speakers 40 and 70 are symmetrical to each other for purposes of user convenience.

The screen display unit 330 outputs the user interface screen received from the screen input and output controller 302.

The wireless communication unit 340 outputs voice data received from the dual microphone 310 or transmits received voice data to the dual speaker 320.

When a key input signal is generated by any one of the first and second hold keys 10 and 30, the key input unit 350 transmits the generated key input signal to the key input controller 301.

The memory unit 360 stores data that is generally used by the terminal 200. In particular, the memory unit 360 stores a table, such as Table 1, in which whether a terminal state corresponds to the normal direction or the reverse direction is previously stored according to a key input signal and a table, such as Table 2, in which terminal settings, such as a key function, a user interface screen direction, a display screen direction, a speaker function, a microphone function, and a touch screen configuration, are previously stored according to the terminal state.

As described above, according to the present invention, convenience of a user interface increases without a complicated sensor system by determining and providing a key map and user interface screen direction, to provide a convenient manipulation according to the direction by which a user handles (i.e., grips) a terminal.

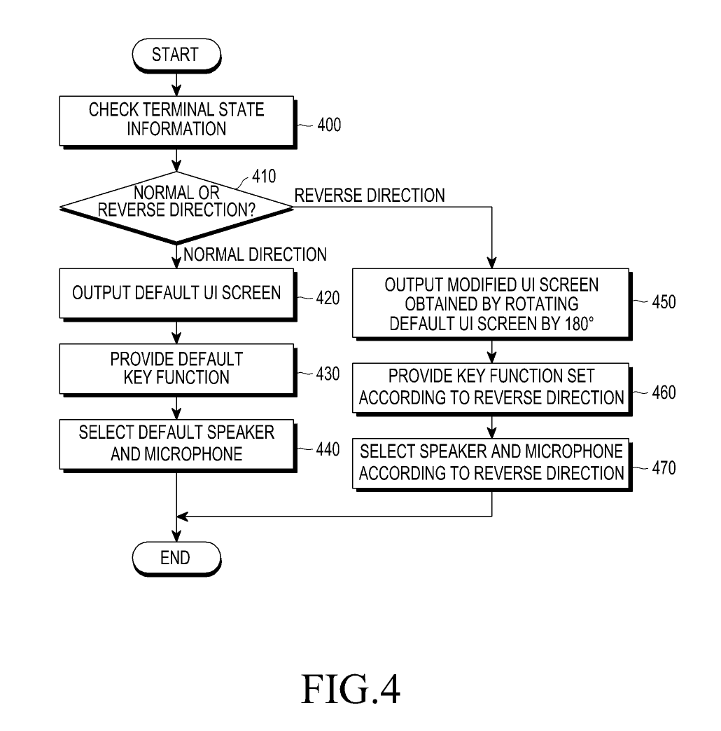

FIG. 4 illustrates a process of providing a user interface screen by the terminal 200 in response to a terminal state change, according to an embodiment of the present invention. Reference to Table 2 will also be made in the description of FIG. 4.

Referring to FIG. 4, in step 400, the key input controller 301 determines terminal state information. In detail, the key input controller 301 determines a hold key, which has output a key input signal, from among the first and second hold keys 10 and 30 based on the received key input signal.

In step 410, the key input controller 301 determines, according to the determined hold key, whether a posture of the terminal 200 corresponds to the normal direction or the reverse direction. If the posture of the terminal 200 corresponds to the normal direction, the screen input and output controller 302 outputs the default user interface screen via the screen display unit 330 in step 420.

In step 430, the key input controller 301 provides a default key function set according to the normal direction. In other words, with reference to Table 2, the key input controller 301 allocates a default hold function to the first hold key 10 and allocates a camera function to the second hold key 30.

In step 440, the voice input and output controller 303 selects a default speaker and microphone according to the normal direction. Specifically, the voice input and output controller 303 determines the first speaker 40 located at the upper part of the terminal 200 as the voice receiver and determines the second microphone 80 located at the lower part of the terminal 200 as the voice transmitter.

If the posture of the terminal 200 corresponds to the reverse direction in step 410, the screen input and output controller 302 outputs a modified user interface screen obtained by rotating the default user interface screen by 180° via the screen display unit 330 in step 450.

In step 460, the key input controller 301 provides a key function set according to the reverse direction. Specifically, the key input controller 301 allocates the camera function to the first hold key 10 and allocates the hold function for performing a hold key function to the second hold key 30.

In step 470, the voice input and output controller 303 selects a speaker and a microphone to be set according to the reverse direction. Specifically, the voice input and output controller 303 determines the first microphone 50 located at the upper part of the terminal 200 as the voice transmitter and determines the second speaker 70 located at the lower part of the terminal 200 as the voice receiver.

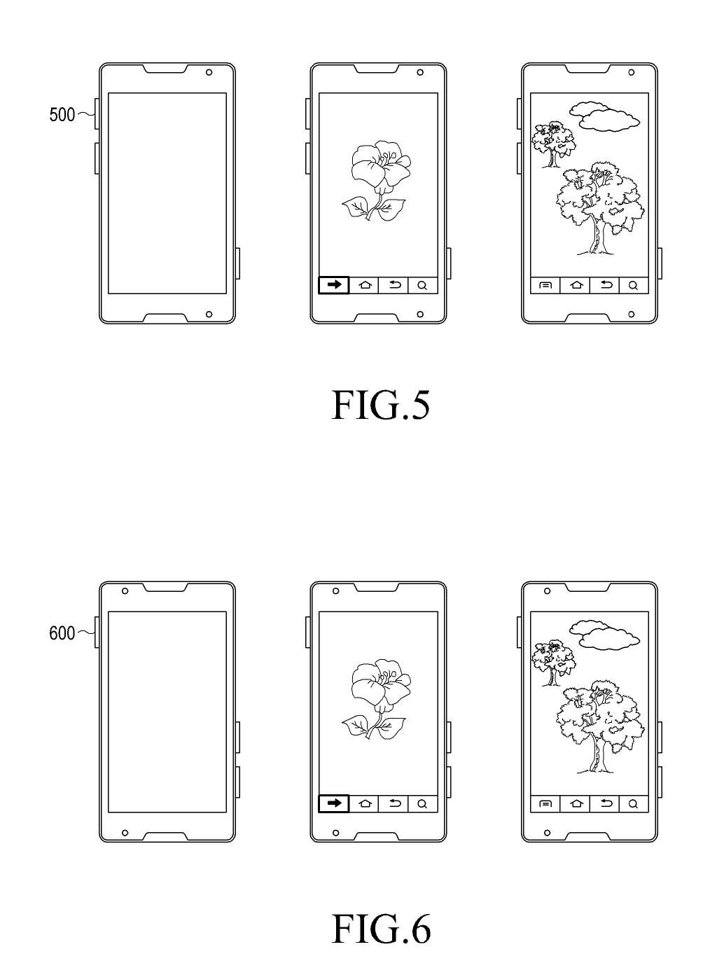

FIG. 5 illustrates an instance in which a posture of the terminal 200 corresponds to the normal direction, according to an embodiment of the present invention.

As shown in FIG. 5, if a key input signal is received from a hold key 500 located at the upper left side of the terminal 200, the key input controller 301 recognizes that the posture of the terminal 200 corresponds to the normal direction, outputs the default user interface screen corresponding to the normal direction via the screen display unit 330, and changes a hold key located at the lower right side of the terminal 200 to a key for executing the camera function.

FIG. 6 illustrates an instance in which the posture of the terminal 200 corresponds to the reverse direction, according to an embodiment of the present invention.

As shown in FIG. 6, if a key input signal is received from a hold key 600 located at the lower right side of the terminal 200, the key input controller 301 recognizes that the posture of the terminal 200 corresponds to the reverse direction, outputs a modified user interface screen obtained by rotating the default user interface screen by 180° via the screen display unit 330, and changes a hold key located at the upper left side of the terminal 200 to a key for executing the camera function.

As described above, according to the present invention, convenience of a user interface increases without use of a complicated sensor system by determining and providing a key map and user interface screen direction, to provide an easy manipulation according to the direction in which a user handles a terminal.

In addition, according to the present invention, a user interface screen is provided without a user having to readjust a posture of a terminal, by determining and providing a key map and user interface screen direction to provide an easy manipulation according to the direction in which a user handles the terminal.

In addition, the present invention can be implemented through modification of a key arrangement and related software without additional hardware of a terminal by determining a user interface screen direction without using a complicated sensor system.

Moreover, according to the present invention, terminal battery consumption is reduced by providing a user interface which clearly reflects a user's intention.

While the invention has been shown and described with reference to certain embodiments thereof, it will be understood by those skilled in the art that various changes in form and details may be made therein without departing from the spirit and scope of the invention as defined by the appended claims and their equivalents.

What is claimed is:

1. A terminal for providing user interfaces linked to postures of the terminal, comprising:
a key input unit having at least two function keys located at left and right sides of the terminal, respectively; and
a controller for determining, when a key input signal is received from any one of the at least two function keys, a posture of the terminal in response to the received key input signal, providing a user interface screen corresponding to the determined posture of the terminal, and changing settings of the terminal according to the determined posture of the terminal.

2. The terminal of claim 1, wherein the at least two function keys comprise a first function key and a second function key that perform a same function.

3. The terminal of claim 2, further comprising a memory unit for storing a first table regarding a posture of the terminal corresponding to inputs of the at least two function keys and a second table regarding terminal settings corresponding to the posture of the terminal.

4. The terminal of claim 3, wherein the terminal settings comprise key function settings, a user interface screen and display screen direction, camera and microphone settings, and settings of a touch screen configuration.

5. The terminal of claim 4, wherein, with reference to the first table, the controller determines that the posture of the terminal corresponds to a normal direction when the key input signal is received from the first function key and determines that the posture of the terminal corresponds to a reverse direction of the normal direction when the key input signal is received from the second function key.

6. The terminal of claim 5, wherein, with reference to the second table, the controller provides a default user interface screen and display screen direction when the posture of the terminal corresponds to the normal direction and provides the user interface screen and display screen direction by rotating the default user interface screen and display screen direction by 180° when the posture of the terminal corresponds to the reverse direction.

7. The terminal of claim 5, wherein, with reference to the second table, the controller performs a terminal setup according to the normal direction when the posture of the terminal corresponds to the normal direction and performs a terminal setup according to the reverse direction when the posture of the terminal corresponds to the reverse direction.

8. The terminal of claim 7, wherein, with reference to the second table, the controller provides default key functions to the first function key and the second function key when the posture of the terminal corresponds to the normal direction and provides key functions corresponding to the reverse direction to the first function key and the second function key when the posture of the terminal corresponds to the reverse direction.

9. The terminal of claim 7, wherein, with reference to the second table, the controller provides default microphone and speaker settings when the posture of the terminal corresponds to the normal direction and provides microphone and speaker settings corresponding to the reverse direction when the posture of the terminal corresponds to the reverse direction.

10. A method of providing user interfaces linked to postures of a terminal, comprising:
receiving a key input signal from any one of at least two function keys located at left and right sides of the terminal, respectively;
determining a posture of the terminal in response to the received key input signal;
providing a user interface screen corresponding to the determined posture of the terminal; and
changing settings of the terminal according to the determined posture of the terminal.

11. The method of claim 10, wherein the at least two function keys comprise a first function key and a second function key that perform a same function.

12. The method of claim 11, further comprising storing a first table regarding a posture of the terminal corresponding to inputs of the at least two function keys and a second table regarding terminal settings corresponding to the posture of the terminal.

13. The method of claim 12, wherein the terminal settings comprise key function settings, a user interface screen and display screen direction, camera and microphone settings, and settings of a touch screen configuration.

14. The method of claim 13, wherein determining the posture of the terminal comprises:
determining that the posture of the terminal corresponds to a normal direction when the key input signal is received from the first function key; and
determining that the posture of the terminal corresponds to a reverse direction of the normal direction when the key input signal is received from the second function key, with reference to the first table.

15. The method of claim 14, wherein providing the user interface screen comprises:
providing a default user interface screen and display screen direction when the posture of the terminal corresponds to the normal direction; and
providing the user interface screen and display screen direction by rotating the default user interface screen and display screen direction by 180° when the posture of the terminal corresponds to the reverse direction, with reference to the second table.

16. The method of claim 14, wherein changing the settings of the terminal comprises:
performing a terminal setup according to the normal direction when the posture of the terminal corresponds to the normal direction; and
performing a terminal setup according to the reverse direction when the posture of the terminal corresponds to the reverse direction, with reference to the second table.

17. The method of claim 16, wherein performing the terminal setup according to the normal direction comprises:
providing default key functions to the first function key and the second function key when the posture of the terminal corresponds to the normal direction; and
providing key functions corresponding to the reverse direction to the first function key and the second function key when the posture of the terminal corresponds to the reverse direction, with reference to the second table.

18. The method of claim 16, wherein performing the terminal setup according to the reverse direction comprises:
providing default microphone and speaker settings when the posture of the terminal corresponds to the normal direction; and
providing microphone and speaker settings corresponding to the reverse direction when the posture of the terminal corresponds to the reverse direction, with reference to the second table.
